(19) United States
(12) Patent Application Publication
(10) Pub. No.: US 2021/0080318 A1
(43) Pub. Date: Mar. 18, 2021

(54) COOKING APPARATUS HAVING LOAD SENSING AND METHOD FOR CONTROLLING THE SAME

(71) Applicant: CLARENCE WHEELER, ATLANTA, GA (US)

(72) Inventor: CLARENCE WHEELER, ATLANTA, GA (US)

(21) Appl. No.: 16/918,943

(22) Filed: Nov. 2, 2020

Related U.S. Application Data
(63) Continuation-in-part of application No. 15/919,186, filed on Mar. 12, 2018, now abandoned.

(51) Int. Cl. G01G 19/52; F24C 15/16

(52) U.S. Cl. CPC G01G 19/52; G01G 3/06; F24C 15/16

(57) ABSTRACT

An cooking apparatus for generating a load capacity of a object. The cooking apparatus may be the likes of a cooking stove appliance. The cooking apparatus further comprises a load capacity apparatus for sensing an object load capacity's.

### BACKGROUND OF THE INVENTION

### Field of the Invention

This invention relates to the field of cooking apparatus and systems. More specifically, the invention comprises improved home cooking appliances and systems which may traditionally upgrade the conventional appliance and system comprising load sensing technology.

### BRIEF SUMMARY OF THE PRESENT INVENTION

The scope of the present invention relates to cooking apparatus. The cooking apparatus may include a body and a door attached to the body to open/close the appliance, the appliance may also include a food heating unit which may be used to heat or warm foods to a certain temperature. A control panel for viewing information and controlling the overall functions of the apparatus etc.

The cooking apparatus may include a load capacity apparatus for sensing a weight of an object and/or item in order to preform load sensing tasks and operations. The cooking apparatus may further comprise a main circuit-board that includes various electronic components mounted thereon to carry out instructions provided by one or more additional components of the cooking apparatus.

### BRIEF DESCRIPTION OF THE SEVERAL VIEWS OF THE DRAWINGS

FIG. 1 is a perspective view illustrating the schematic configuration of a cooking apparatus according to an exemplary embodiment of the present invention.

FIGS. 2a and 2b is a perspective view illustrating the schematic configuration of a cooking apparatus oven portion according to an exemplary embodiment of the present invention.

FIG. 3a is an exploded perspective view illustrating a load capacity apparatus.

FIG. 3b is a block diagram of the load capacity apparatus included in the cooking apparatus oven portion according to the present invention.

FIG. 4 is a exploded perspective view illustrating a load capacity apparatus included on cooking apparatus stove-top panel according to the present invention.

FIG. 5 is a exploded perspective view illustrating a load capacity apparatus included on cooking apparatus stove-top panel according to the present invention.

FIG. 6 is a schematic view illustrating the stove-top panel according to the present invention.

### DETAILED DESCRIPTION OF THE PREFERRED EMBODIMENT(S)

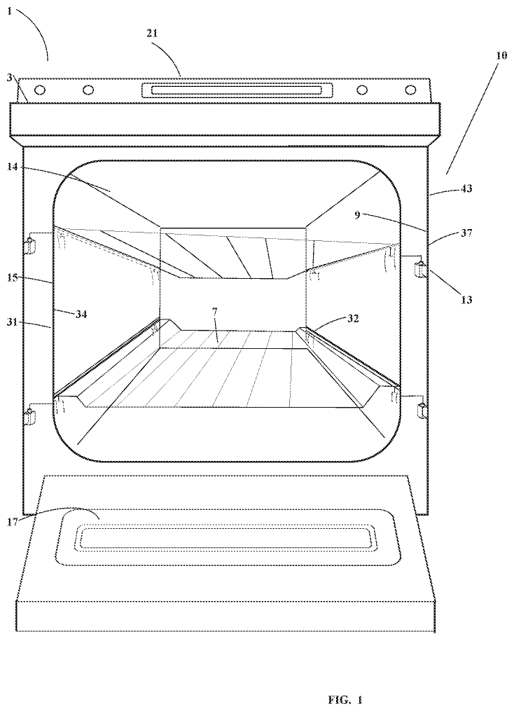

Referring to FIG. 1 shown is cooking apparatus 1 (e.g., radiant-heat cooktops, electric-range and gas stove) type appliance 1. Cooking apparatus 1 comprises body 10 having oven portion 30, door 17 pivotally to open and close disposed at front surface of body 10, a stove-top panel 3 disposed at top side of body 10 configured to heat one or more objects, a control panel 21 formed at one side of cooking apparatus 1 body 10 configured to allocate a user to control one or more operations of cooking apparatus 1, such operations may be to control a cooking temperature of the one or more element(s) or oven portion 30. Control panel 21 may comprises one or more adjustment mechanisms to control the cooking temperatures as task such as nobs, a display panel etc.

Further, body 10 includes stove-top panel 3 having a stove-top hood constituting a exterior surface of stove-top panel 3, and a lower-panel respective coupled to stove-top hood constituting a interior surface of stove-top panel 3. Stove-top hood 25 may comprises an array of burner areas configure to receive panel insert(s). Stove-top panel 3 comprise one or more elements (e.g., burners or coils) for heating one or more object disposed on panel inserts.

Furthermore, body 10 oven portion 30 comprises inner case 31 constituting

a cooking chamber, and a outer case 43 constituting a exterior surface. Inner case 31 forms inner surface 34 and outer surface 15 constituting the interior of oven portion 30.

Outer case 43 forms inner surface 9 and outer surface 37 constituting the exterior of oven portion 30. Door 17 pivotally rotatably disposed at a front side of body 10. One or more means for receiving oven rack 7 formed on inner surface 34, such means may be one or more openings 5 or guides 32.

One or more load capacity apparatus 13 respectively disposed on outer case 43 inner surface 9 configured to generate and distribute one or more load capacity signals corresponding to the weight sensed of the object disposed on oven rack 7. Further, each respective load capacity apparatus 13 comprises extending segment extending from each load capacity apparatus 13 body, further a top-side of each extending segment is disposed within openings 5 formed on guides 32. For instance, load capacity apparatus 13 may be the likes of a scale (digital or analog, a pressure or weight sensor etc.).

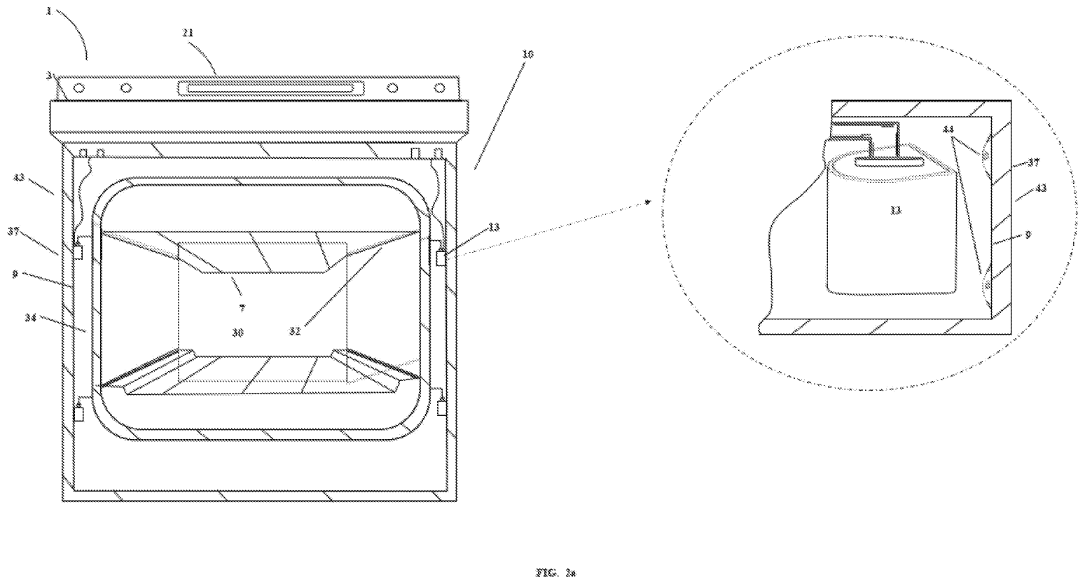

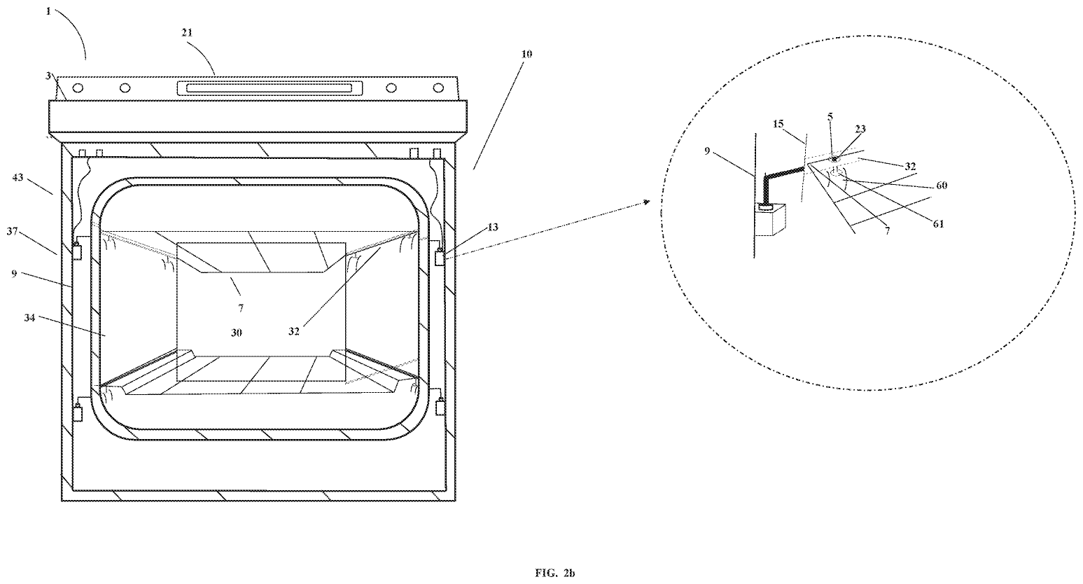

According to FIGS. 2a & 2b shown is cooking apparatus 1 (e.g., radiant-heat cooktops, electric-range and gas stove) type appliance 1. As described in FIGS. 1A-1C cooking apparatus 1 comprises body 10 having a oven portion 30, stove-top panel 3, a control panel 21, oven portion 30, outer case 43 and inner case 31.

Oven portion 30 outer case 43 includes inner surface 9 and outer surface 37 constituting outer case 43 inner and outer surfaces. Specifically, inner surface 9 comprises a plurality of protrusions 44 projecting from inner surface 9 adjacent each other, each protrusions 44 has a threaded opening configured to allocate coupling of one or more load capacity apparatus 13 to inner surface 9. Alternatively, inner surface 9 may comprise a thin panel coupled to its surface having the one or more protrusions 44 formed on thereof.

Oven portion 30 inner case 31 also includes inner surface 34 and outer surface 15 constituting inner case 31 inner and outer surfaces. Inner surface 34 comprises one or more guides 32 adjacent each other configured to receive rack 7, each guide 32 has one or more openings 5 therefore receiving extending segment 23. Further, a plurality of vertical recess 60 formed on outer surface 15 having opening formed at top surface so that extending segment 23 can project towards opening 61. Specifically, recess 49 projects inward towards inner surface 34 intermediate guides 32 and assembles counterpart with openings 5 formed on guides 32.

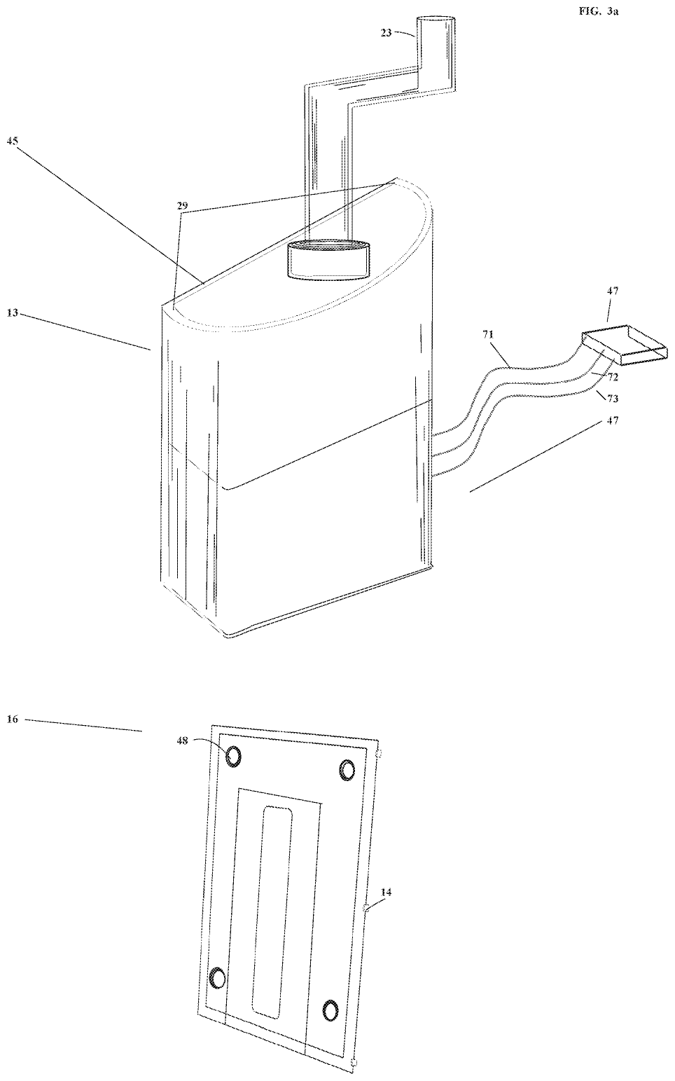

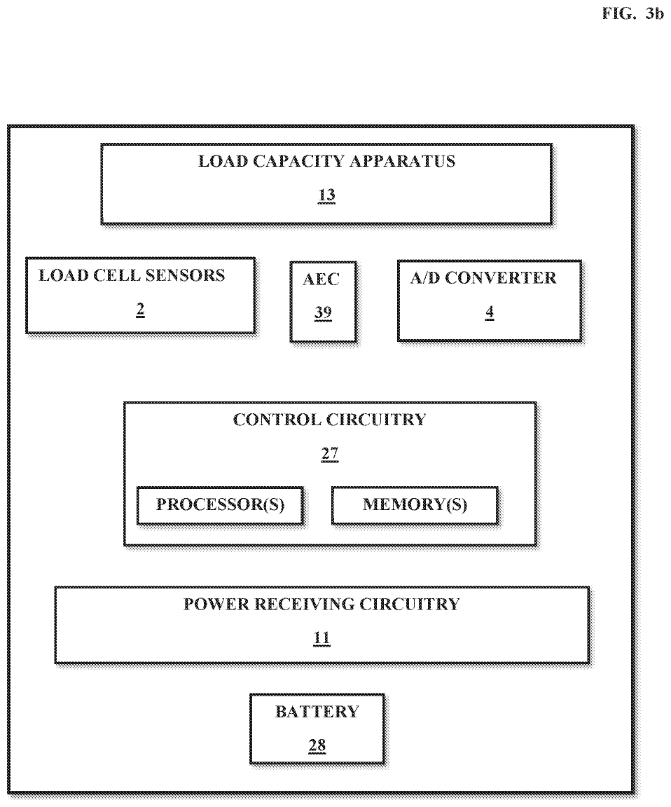

Further, when extending segment 23 is disposed within opening 5 extending segment 23 partially projects through opening(s) 5 so the rack 7 can glide freely within guide(s) 32. FIG. 3a is an exploded perspective view illustrating a load capacity apparatus 13, while FIG. 3b is a block diagram of the load capacity apparatus 13 included in the cooking apparatus 1 oven portion 30 according to the present invention.

Further, load capacity apparatus 13 comprises housing 45 having platform 18 elevated by respective supports 29 at predetermine positions corresponding to the perimeter regions of platform 18. Housing 45 further comprise respective elbow-shape extended segment(s) 17 at opposing side housing 45, which allocate load capacity apparatus 13 to respectively couple to the one or more protrusions 44 of inner surface 9. Platform 18 refers to top surface housing 45 which contains all analog and digital electronic circuitry, sensor devices and other components for load capacity sensing apparatus 20. Specifically, platform 18 comprises a opening 26 extending from its body, opening 26 comprises a threaded interior configured to receive extending segment 23 therefore. Extending segment 23 also comprises threaded end region for coupling to opening 26. The housing 45 also includes back plate 16 coupled to rear surface of housing 45 enclosing rear surface of housing 45. Back plate 16 includes one or more clips 14 at various positions for coupling to rear surface of housing 45. One or more opening 48 are formed on back plate 16 cross-sectional each so that back plate 16 securely couples to protrusion(s) 44 formed on the inner surface 9. The coupling can be where screw(s) are inserted into openings 48 from front side of back-plate and screwed into protrusion(s) 44 supporting the connection of the back-plate 16 to inner surface 9 and housing 45 is coupled to back plate 16 via clips 14.

Support 29 can comprise load cell sensor 2 which contains a sensor plate with strain gauges in conventional fashion, strain gauges can be typically intercoupled in a conventional bridge configuration, wherein one leg includes strain gauges T1 and C1 in tension and compression respectively, while the opposing leg includes strain gauges C2 and T2 in compression and tension respectively, under load conditions.

More of, load cell assembly sensors may operate to sense an force resulting from rack 7 resting on extending segment 23 and extending segment applying force to platform 18, when this occurs a analog signal is generated indicative of the sensed force. The analog signal may be input into a conventional analog electronic circuitry for a signal calibration or amplification and the likes for conditioning a sensed analog signal. The processed analog signal may be output from AEC (Analog Electronics Module) 39 for input into analog format to digital converter 20 for converting analog format into digital format.

Load sensing apparatus 13 further comprises control circuitry 27 disposed within housing 45 and operates in response to Analog/Digital (A/D) converter 4 which provides digitized sensor input data from load cell sensor(s) 2 for generating a digital signal input to control circuitry 27 in order to display a load capacity number value on control panel 21 (e.g., display).

Control circuitry 27 may be used in controlling the operation of load capacity apparatus 13. Control circuitry 27 may include a processing circuitry associated with microprocessors, power management units, baseband processors, digital signal processors, microcontrollers, and/or applications-specific integrated circuits with processing circuits. The processing circuitry implements desired control and communications features in the load capacity apparatus 13. For example, processing circuitry may be used in determining power transmission levels, processing sensor data (load cell sensors), handling negotiations between load capacity apparatus 13 and control panel 21.

Control circuitry 27 may be configured to perform operations in load capacity apparatus 13 using hardware (e.g., dedicated hardware or circuitry), firmware and/or software. Software codes for performing operations in load capacity apparatus 13 may be stored on non-transitory computer readable storage media (e.g., tangible computer readable storage media) in control circuitry 27. The non-transitory computer readable storage media may include non-volatile memory such as non-volatile random-access memory (NVRAM) or the likes. The software stored on the non-transitory computer readable storage media may be executed on the processing circuitry of control circuitry 27. The processing circuitry may include application-specific integrated circuits with processing circuitry, one or more microprocessors, a central processing unit (CPU) or other processing circuitry.

Control circuitry 27 may be used to run software, such as applications and operating system functions, etc. To support interactions with external equipment, the control circuitry 27 may be used in implementing communications protocols.

For, instance the control circuitry 36 may comprises an application or software that obtains the digital signal via the Analog/Digital (A/D) converter 58 and converts the encrypted data into an actual number value, in response the application or software control circuitry 36 may distribute the number value to memory or control panel 21 (e.g., display). The communications protocols that may be implemented using control circuitry 27 includes internet protocols, wireless local area network protocols (e.g., IEEE 802.11 protocols—sometimes referred to as WiFi®), protocols for other short-range wireless communications links such as the Bluetooth® protocol, antenna diversity protocols, satellite navigation system protocols, millimeter wave communications protocols, IEEE 802.15.4 ultra-wide band communications protocols, etc.

Load capacity apparatus 13 may include a power receiving circuitry 11 that may be a off-chip ex. (module) or on-chip, duties to manage the power of load capacity apparatus 13. The power receiving circuitry 11 may include a power management IC (PMIC) or a charger IC for example. PMIC may have wired and/or wireless charging capabilities. The wireless charging process may be a magnetic resonance process, a magnetic induction process, or an electromagnetic process, an additional circuit for wireless charging, such as a circuit, a coil loop, a resonant circuit, or a rectifier circuit.

Battery 28, for example, may be a rechargeable battery. In the case of a on-chip power management circuit (not illustrated), includes one or more DC-DC converters, voltage regulators, current regulators, maximum Power Point Tracking (MPPT) device or other power supplies supplying data and optionally other components of load capacity apparatus 13 and/or its peripheral devices with supply voltages and or currents that may be required to power load capacity apparatus 13. The on-chip power management circuit may operate from one or more batteries, solar power source, line power, mechanical power source, photovoltaic power source, thermal power source, radio frequency (RF) power source, vibration power source, bio-mechanical power source, fuel cell and/or any other power source. In particular, the on-chip power management module may selectively supply power supply signals of different voltages, currents, current limits or with adjustable voltages, currents or current limits in response to power mode signals received. The on-chip power management circuit may be implemented as a multi-output programmable power supply, that may receive power and may generate optionally routes power supply signals to a particular port, pin or pad or directly to peripheral devices via a switch matrix, as commanded based on the power mode signal.

In addition, over portion 30 may comprise at least one opening formed on its surface for allocating the wiring harness 47 to coupled to control panel 21 mainboard.

Further, wiring lead(s) 47 is connected to control circuitry 47 thereon for transmitting/receiving data to and from control panel 21 and load capacity apparatus 13. For example, control panel 21 may comprise one or more ports for receiving wiring lead(s) 47 such mentioned ports may be defined by having one or more pins such as a data pin, ground pin, and power receiving pin. The ports may be in connection with wiring leads 47 via a connector. Specifically, wiring lead(s) 47 comprises data lead 71, a power lead 72, and ground lead 72. For instance, data lead 71 transmit data (e.g., signals) to and from load capacity apparatus 13 and control panel 21, such data may be to transmit a load capacity value, the battery 28 capacity levels or a data carrier current to boot control circuit 27. Ground lead 72 stabilize power to and from load capacity apparatus 13. Power receiving lead 72 receives power from port to charge battery 28 and boot control circuit 27.

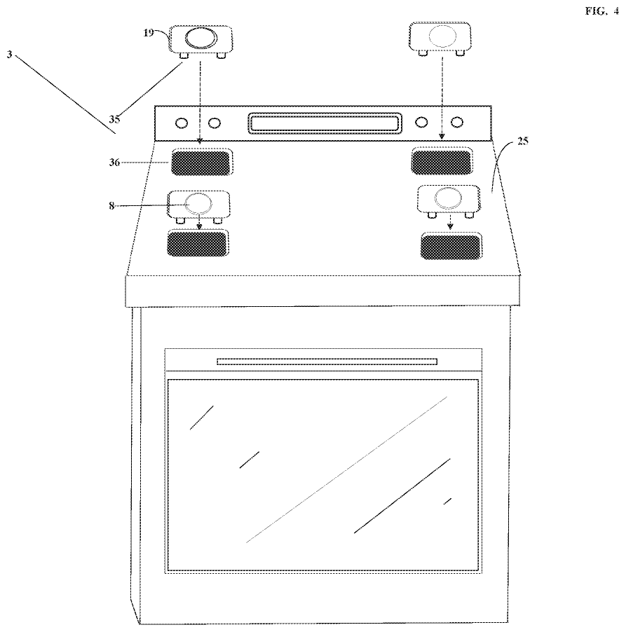

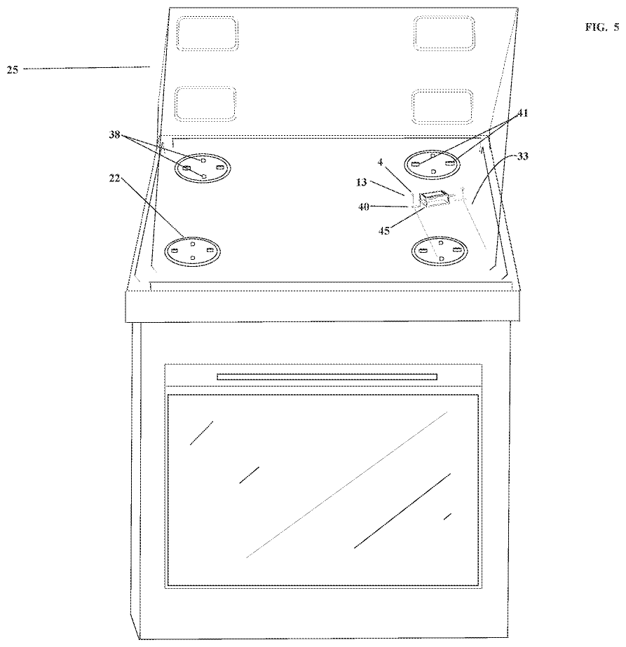

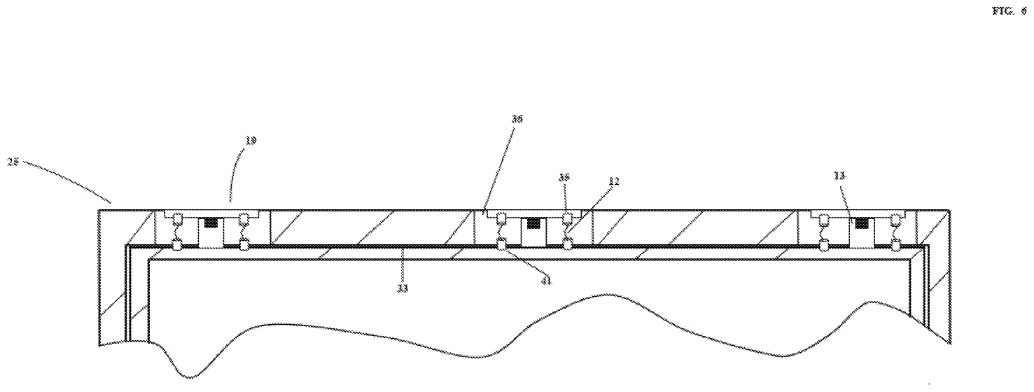

FIG. 4-6 is an exploded perspective view illustrating a load capacity apparatus 13 included on cooking apparatus 1 stove-top panel 3 according to the present invention. As mentioned above in FIGS. 1a & 1b, body 10 includes stove-top panel 3 having a stove-top hood 25 constituting a exterior surface of stove-top panel 3, and a lower-panel 33 respective coupled to stove-top hood 25 constituting a interior surface of stove-top panel 3.

Stove top panel 3 may also be made of a glass-ceramic material. Stove-top hood 25 may comprises an array of panel openings 36 configure to receive each panel insert 19. Stove-top panel 3 comprise one or more elements 22 (e.g., burners or coils) for heating the one or more object disposed on panel insert 19.

Panel insert 19 forms a thin structure made of a glass-ceramic material. Panel insert 19 further comprises a vessel(s) 8 at a top surface of its body for transferring heat from element(s) 22 to a object placed on panel insert 19. Further, panel insert 19 includes small opening(s) 35 at bottom surface slightly projecting from its body at opposing sides thereof for receiving coil spring(s) 12 intended to couple panel insert 19 to lower panel 33. Provided on top surface of lower panel 33 at each element(s) 22 opening(s) 41 are formed cross-sectional each projecting upward for receiving coil spring(s) 12 coupling panel insert 19 to lower panel 33 this coupling allocates panel insert 19 to flex spontaneously in motion in response to a object being placed on panel insert 19 and assemble on top of load capacity apparatus 13.

The top surface of lower panel 33 comprises one or more protrusions 38 also formed at each element(s) region 42 cross-sectional each. The one or more protrusions 38 also includes a threaded opening 24 for coupling load capacity apparatus 13 to lower panel 33.

More specifically, when referring to load capacity apparatus 13 of stove top panel 3, load capacity apparatus 13 comprises the same components and structure as mentioned in FIGS. 3a & 3b. However, housing 45 includes member(s) 40 forming elbow-shape extending downward from its body at each side cross-sectional which couples to lower panel 33. Member 40 includes opening(s) 6 at a end region for receiving screw(s) 46 and coupling to protrusions 44. In addition, lower panel 33 may comprise at least one opening formed on its surface for allocating the wiring leads 47 to coupled to control panel 21 mainboard.

Although the preceding description contains significant detail, it should not be constructed as limiting the scope of the invention but rather as providing illustration of the preferred embodiments of the invention. Such a variation would not materially alter the nature of the said invention. Thus, the scope of the invention should be fixed by the following claims rather than any specific examples provided.

Having thus described my invention, what is now claimed:

1. A cooking apparatus comprising:
a cooking chamber having a outer case, wherein the outer case comprises inner surface 9, and wherein the inner surface 9 comprises a means of coupling at least one load capacity apparatus to the inner surface 9;
a inner case having a inner surface 34 and a outer surface 15, and wherein the inner surface 34 comprises at least one guide formed on the inner surface 34, and wherein the inner surface 34 comprises a means for receiving a top side of a extending segment in order to generate a load capacity signal in response to a object placed on a oven rack; and wherein the outer surface 15 composes a function for receiving the extending segment in order for the top side of the extending segment to protrude to a opening of the at least one guide; and
a stove-top hood having one or more panel openings for receiving one or more panel inserts, and wherein the one or more panel inserts comprises a means for coupling to a lower panel;
wherein the load capacity apparatus is configured to generate a load capacity signal, and wherein the load capacity signal is generated in response to the object placed on the oven rack;
wherein the load capacity apparatus is configured to generate a load capacity signal, and wherein the load capacity signal is generated in response to the object placed on the panel insert.

2. The cooking apparatus of claim 1, wherein the inner surface 9 comprises a plurality of protrusions projecting from the inner surface 9, and wherein the plurality of protrusions has a threaded opening configured to allocate coupling the at least one load capacity apparatus to the inner surface 9.

3. The cooking apparatus of claim 1, wherein the at least one guide comprises a opening for receiving the top side of the extending segment.

4. The cooking apparatus of claim 1, wherein the outer surface 15 comprises a plurality of vertical recess, and wherein the plurality of vertical recess comprises a opening formed at a top side so the extending segment can project towards a opening 61 and further projects towards the opening 5 formed on the at least one guide.

5. The cooking apparatus of claim 1, further comprising the at least one load capacity apparatus coupled to the inner surface 9 comprises a housing having a means for receiving the extending segment, wherein the housing comprises a platform having a opening extending from a body.

6. The cooking appliance of claim 5, further comprising the housing comprises a back plate having means for coupling the load capacity apparatus to the inner surface 9, wherein the back plate comprises a plurality of opening, and wherein a screw is disposed within the plurality of openings and screwed into the plurality of protrusions.

7. The cooking apparatus of claim 1, wherein the one or more panel inserts comprises a small opening(s) at bottom surface slightly projecting from a body, and wherein the small openings is configured to receive one side of a coil spring(s), and wherein the lower panel comprises at least one opening(s) formed on a top side for receiving an opposing side of the coil spring(s).

8. The cooking apparatus of claim 1, further comprising the panel insert comprises a vessel(s).

9. The cooking apparatus claim 1, further comprising the load capacity apparatus is coupled to the lower panel.

10. The cooking apparatus component of claim 1, wherein the cooking apparatus is a stove.
